(19) United States
(12) Patent Application Publication
(10) Pub. No.: US 2025/0249749 A1
(43) Pub. Date: Aug. 7, 2025

(54) ENHANCED POWER MODE SYSTEM AND METHOD FOR KEY-OFF FEATURE OPERATION IN ELECTRIC VEHICLES

(71) Applicant: Ford Global Technologies, LLC, Dearborn, MI (US)

(72) Inventors: Stuart C. Salter, White Lake, MI (US); Michael Duke, Livonia, MI (US); Jessica Louise Smith, Brighton, MI (US); David Celinske, Wolverine Lake, MI (US); Todd Ansbacher, Westland, MI (US); Brendan Diamond, Grosse Pointe, MI (US)

(73) Assignee: Ford Global Technologies, LLC, Dearborn, MI (US)

(21) Appl. No.: 18/435,057

(22) Filed: Feb. 7, 2024

(51) Int. Cl. B60L 1/00; B60L 58/12; G06F 1/3212

(52) U.S. Cl. CPC B60L 1/00; B60L 58/12; G06F 1/3212; B60L 2250/20

(57) ABSTRACT

A vehicle including a transceiver and a processor is disclosed. The transceiver may be configured to receive a charging station location. The processor is configured to determine that the vehicle is in a key-off mode. Responsive to determining that the vehicle is in the key-off mode, the processor may determine at least one of a vehicle State of Charge (SOC) level or a vehicle distance from the charging station location based on a current vehicle location. The processor may further determine that a predefined condition is met based on the at least one of the vehicle SOC level or the vehicle distance. Responsive to a determination that the predefined condition is met, the processor may select a vehicle feature from a plurality of vehicle features based on historical usage pattern of the plurality of vehicle features in the key-off mode, and enable a high-power mode of the vehicle feature.

### FIELD

The present disclosure relates to electric vehicles (EVs), and more particularly to an enhanced power mode system and method for key-off feature operation in EVs.

### BACKGROUND

Typically when a vehicle is turned off (or not being used), one or more vehicle modules shut down to conserve vehicle power. As the modules shut down, certain vehicle features may not operate at all, or may operate with a lag/delay. For example, when the vehicle is turned off, the vehicle camera and/or the vehicle microphone do not constantly buffer/record signals, to conserve vehicle power. In this case, if a malicious user attempts to break into the vehicle, the break-in attempt may not get recorded or may get recorded with a delay when the camera and/or the microphone may start recording. Such an instance may cause inconvenience to the vehicle owner. In another example, when the vehicle is turned off, vehicle exterior lights for welcome feature/function may be activated with a delay when the vehicle owner approaches the vehicle. Similarly, a display screen may boot-up with a delay when the vehicle may be turned off. Such instances may affect user's experience of operating the vehicle.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 depicts an example environment in which techniques and structures for providing the systems and methods disclosed herein may be implemented.

FIG. 2 depicts a block diagram of a system for operating/engaging vehicle feature(s) in a key-off scenario in accordance with the present disclosure.

FIG. 3 depicts a snapshot of a scenarios in which the vehicle features are engaged in a high-power mode in accordance with the present disclosure.

FIG. 4 depicts a flow diagram of a method for operating/engaging vehicle feature(s) in a key-off scenario in accordance with the present disclosure.

### DETAILED DESCRIPTION

### Overview

The present disclosure describes a vehicle having a key-off unit configured to control operation of vehicle feature(s) when the vehicle may be in a key-off mode. The unit may be configured to maintain a balance between high performance and power consumption of vehicle features while the vehicle may be in the key-off mode. The unit may prioritize high performance when the vehicle power consumption required to operate the vehicle features may not be of concern.

When the power consumption may not be a concern, the unit may enable a high-power mode (or a high-performance mode) for all the vehicle features that typically operate in the key-off mode. In an exemplary aspect, the power consumption may not be a concern when a vehicle State of Charge (SOC) level may be greater than 80% (or a predefined SOC threshold) and/or the vehicle may be located in proximity to a home/charger location. On the other hand, when the power consumption may be a concern, the unit may engage a first set of vehicle features in a high-power mode and engage a second set of vehicle features in a low-power mode. In an exemplary aspect, the power consumption may be a concern when the vehicle SOC level may be 30% (or less than the predefined SOC threshold) and/or a vehicle distance from the home/charger location may be greater than 30 miles (or a predefined distance threshold).

In some aspects, the unit may determine a probability of using a vehicle feature in the key-off mode, and select the vehicle feature for operation when the probability of using the vehicle feature in the key-off may be greater than a predetermined threshold. In an exemplary aspect, the unit may determine the probability based on historical usage pattern of the plurality of vehicle features in the key-off mode. In some aspects, the historical usage pattern may include information associated with a pattern of vehicle feature usage during key-off mode by different vehicle users, how a vehicle user uses the vehicle feature at different locations and at different times of the day, usage frequency of vehicle features, average time spent by the vehicle user at different locations, vehicle charging pattern (e.g., frequency of charging vehicle), and/or the like.

In addition, the unit may select the vehicle feature for operation in the key-off mode based on the vehicle SOC level, power consumption associated with the vehicle feature, a vehicle current location, an ambient temperature, a time of a day, a day of week, information included in a vehicle user calendar, an identity of a user who last drove the vehicle, and an identity of a user who is around the vehicle, and/or the like.

The present disclosure discloses a vehicle unit that may be configured to enhance user experience in key-off scenarios. The unit maintains a balance between the power consumption associated with the vehicle features and the high performance of the vehicle features. In addition, the unit enables the vehicle user to use the vehicle features without any delay, thereby enhancing user experience of operating the vehicle.

These and other advantages of the present disclosure are provided in detail herein.

### Illustrative Embodiments

The disclosure will be described more fully hereinafter with reference to the accompanying drawings, in which example embodiments of the disclosure are shown, and not intended to be limiting.

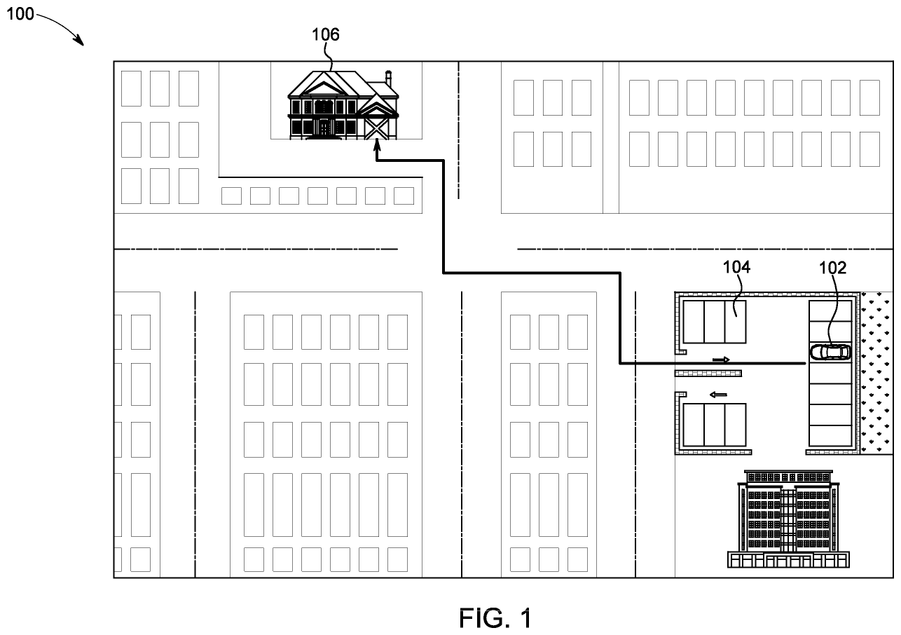

FIG. 1 depicts an example environment 100 in which techniques and structures for providing the systems and methods disclosed herein may be implemented. The environment 100 may include a vehicle 102. The vehicle 102 may take the form of any passenger or commercial vehicle such as, for example, a car, a work vehicle, a crossover vehicle, a van, a minivan, a truck, a taxi, a bus, etc. Further, the vehicle 102 may be a manually driven vehicle and/or be configured to operate in a fully autonomous (e.g., driverless) mode and/or partially autonomous mode. In some aspects, the vehicle 102 may include a traction battery or battery pack (“vehicle battery”, not shown) that may provide energy for vehicle propulsion. Although FIG. 1 depicts a four-wheeler vehicle, the present disclosure may also be applied to two-wheeler vehicles such as electric bicycles, scooters, motorcycles, etc.

In some aspects, the vehicle 102 may be parked in a parking facility 104, as shown in FIG. 1. The vehicle 102 may be in a key-off mode (e.g., a vehicle ignition may be in an off state) when the vehicle 102 may be parked at the parking facility 104. In an exemplary aspect, the parking facility 104 may be associated with any infrastructure including, but not limited to, a shopping complex, a grocery store, a sports complex, a park, and/or the like. In some aspects, the parking facility 104 may be located at a non-zero distance from a home 106 of a vehicle user associated with the vehicle 102 or at a non-zero distance from a charging station/charger (not shown) from where the vehicle 102 may get charged. In other aspects, the parking facility 104 may include one or more charging stations, or the vehicle 102 may be parked at the home 106 (instead of being parked at the parking facility 104).

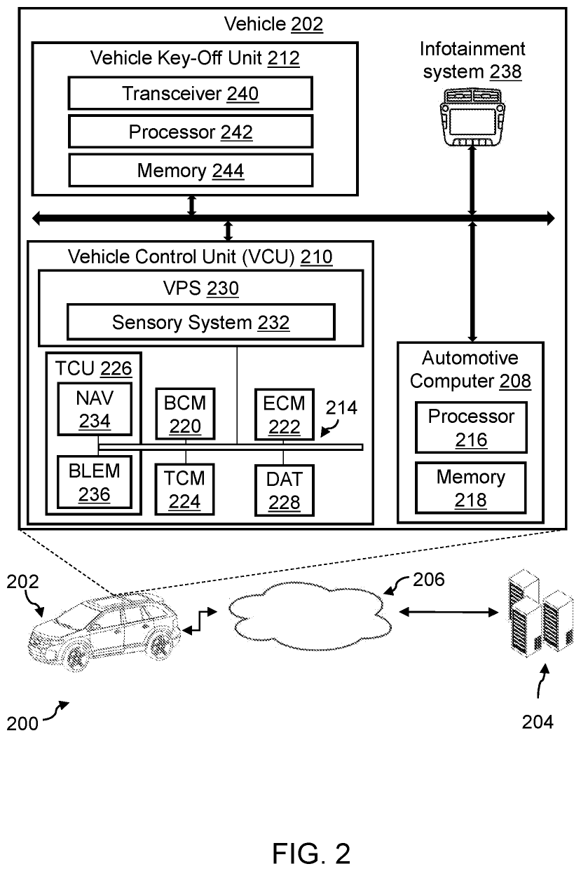

In further aspects, the vehicle 102 may include a key-off unit (e.g., shown as vehicle key-off unit 212 in FIG. 2) that may enhance user experience when the vehicle 102 may be in the key-off mode. In some aspects, when the vehicle 102 may be in the key-off mode, the unit may determine/identify one or more first vehicle features, from a plurality of vehicle features that may enter or be operated in a high-power mode or high-performance mode during key-off situations. In addition, the unit may determine/identify one or more second vehicle features, from the plurality of vehicle features that may remain inactive or be operated in a low-power/low-performance mode during key-off situations. In the high-power mode, the vehicle feature may operate with full performance/capacity (e.g., without affecting vehicle feature performance to conserve vehicle power, and operate without any delay). In the low-power mode, the vehicle feature may either remain inactive or may operate with a partial/low capacity to conserve vehicle power. In an exemplary aspect, the vehicle feature may be activated with a delay in the low-power mode.

In some aspects, the plurality of vehicle features that may operate in the key-off mode may include, but is not limited to, a vehicle security feature in which vehicle cameras may detect adverse situations associated with the vehicle 102 such as vehicle impairment, welcome feature/function in which vehicle exterior lights may be activated when a user approaches in proximity to the vehicle 102, and/or the like.

In some aspects, the unit may engage/enable the high-power mode for all vehicle features in the key-off mode when vehicle power consumption may not be a concern. As an example, the unit may engage/enable the high-power mode for all vehicle features in the key-off mode when the vehicle 102 may be plugged to a charger/charging station, when a vehicle State of Charge (SOC) level may be greater than a first predetermined threshold (such as more than 80% SOC level), when a distance from vehicle current location (e.g., the parking facility 104) and a charging station location (e.g., the home 106) may be less than a second predetermined threshold or a remaining distance to be travelled by the vehicle 102 to the charging station location may be less than the second predetermined threshold (e.g., when the vehicle 102 may be in proximity to the charger), when the unit receives a manual request from a vehicle user (e.g., via a vehicle Human-Machine Interface (HMI)) to enable the vehicle feature(s), when an authorized user or an authorized vehicle key may be located within a predefined range (e.g., 3-5 feet) of the vehicle 102 in a recent time duration (e.g., the vehicle owner walked by the vehicle 102 five minutes ago) as determined via vehicle's exterior sensor suite and vehicle-to-infrastructure (V2I) communication from an infrastructure based sensor suite, when the vehicle 102 may be located at a predefined specific location, and/or the like. In some aspects, the charging station location may include a location associated with an electric vehicle charging station or a fuel station for a hybrid vehicle.

The examples described above should not be construed as limiting, and the unit may engage/enable the high-power mode for all vehicle features in the key-off mode in any other scenario as well, without departing from the present disclosure scope.

On the other hand, the unit may engage/enable the high-power mode for a set of vehicle features (or one or more selected vehicle features) when the power consumption associated with the vehicle features in the key-off mode may be a concern, and may engage a low-power mode for other/non-selected vehicle features. In this case, the unit may first determine whether a predefined condition may be met, before enabling some vehicle to operate in the high-power mode and the remaining features in the low-power mode. The predefined condition may be met when the vehicle power consumption may be a concern. As an example, the predefined condition may be met when the vehicle SOC level may be less than a third predetermined threshold (e.g., less than 40% SOC) and/or the distance from the vehicle current location to the charging station location may be greater than a fourth predetermined threshold (e.g., greater than 100 miles). Responsive to a determination that the predefined condition may be met, the unit may select one or more vehicle features from the plurality of vehicle features in the key-off mode, and enable the high-power mode for the selected vehicle features. In some aspects, the unit may select the vehicle features based on historical usage pattern of the plurality of vehicle features in the key-off mode, the vehicle SOC level, the power consumption associated with each vehicle feature, and/or the like.

As an example, when the vehicle SOC level may be greater than 80% and the vehicle 102 may only be 10 miles from the home location, the unit may engage all the vehicle features in the high-power mode (as the vehicle 102 may not face power shortage while travelling). On the other hand, when the vehicle SOC level may be between 10-40%, the unit may select one or more vehicle features, from the plurality of vehicle features, to engage in the high-power mode based on the historical usage pattern, and enable only the selected vehicle features to operate in in the high-power mode (as the vehicle 102 may face power shortage/challenge in this case while travelling). In this manner, the vehicle 102 ensures that user-preferred/necessary vehicle features (and not other vehicle features) continue to operate in the high-power/high-performance mode even when the vehicle power consumption may be a concern, thus enhancing user convenience of operating the vehicle 102.

Further vehicle details are described below in conjunction with FIG. 2.

The vehicle 102 may implement and/or perform operations, as described here in the present disclosure, in accordance with the owner manual and safety guidelines. In addition, any action taken by the vehicle operators based on the notifications provided by the vehicle 102 should comply with all the rules specific to the location and operation of the vehicle 102 (e.g., Federal, state, country, city, etc.). The notifications, as provided by the vehicle 102, should be treated as suggestions and only followed according to any rules specific to the location and operation of the vehicle 102.

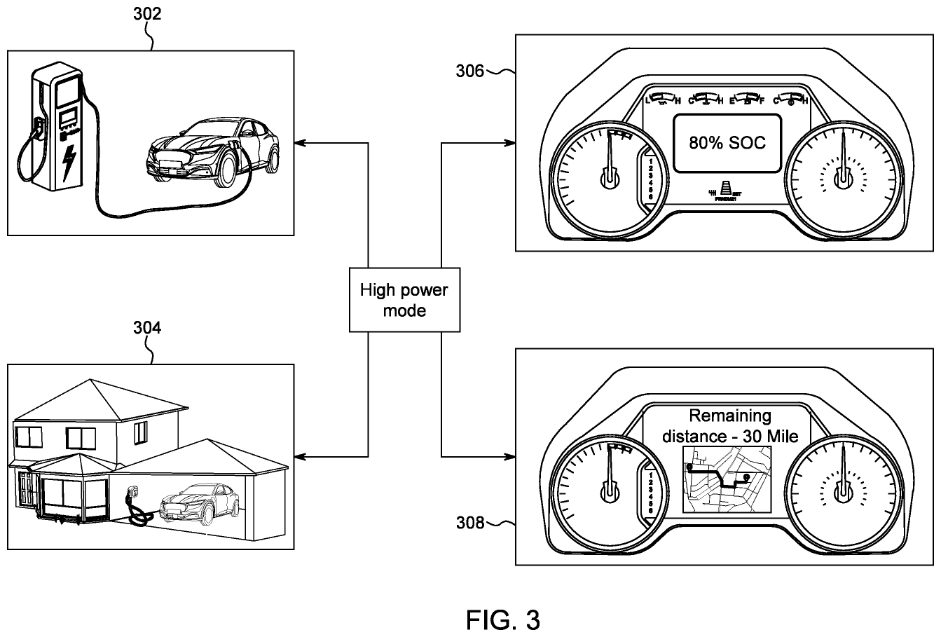

FIG. 2 depicts a block diagram of a system 200 for operating/engaging vehicle feature(s) in key-off scenario in accordance with the present disclosure. While describing FIG. 2, references will be made to FIG. 3.

The system 200 may include a vehicle 202 (same as the vehicle 102) and one or more servers 204 (or server 204) communicatively coupled with each other via one or more networks 206 (or a network 206). The server 204 may be part of a cloud-based computing infrastructure and may be associated with and/or include a Telematics Service Delivery Network (SDN) that provides digital data services to the vehicle 202, and other vehicles (not shown) that may be part of a vehicle fleet. In further aspects, the server 204 may store historical usage pattern of the plurality of vehicle features associated with the vehicle 202 in the key-off mode, vehicle user settings/inputs, and/or the like. For example, the server 204 may store a location, time, day, etc., at which the vehicle user uses specific vehicle features. In addition, the server 204 may store information associated with charging stations including charging station locations. The server 204 may transmit the historical usage pattern and/or the information associated with charging stations to the vehicle 202 at a predefined frequency, or when the vehicle 202 transmits a request to the server 204 to obtain such information.

The network 206 illustrates an example communication infrastructure in which the connected devices discussed in various embodiments of this disclosure may communicate. The network 206 may be and/or include the Internet, a private network, public network or other configuration that operates using any one or more known communication protocols such as, for example, transmission control protocol/Internet protocol (TCP/IP), Bluetooth®, BLE, Wi-Fi based on the Institute of Electrical and Electronics Engineers (IEEE) standard 802.11, ultra-wideband (UWB), and cellular technologies such as Time Division Multiple Access (TDMA), Code Division Multiple Access (CDMA), High-Speed Packet Access (HSPDA), Long-Term Evolution (LTE), Global System for Mobile Communications (GSM), and Fifth Generation (5G), to name a few examples.

The vehicle 202 may include a plurality of units including, but not limited to, an automotive computer 208, a Vehicle Control Unit (VCU) 210, and a vehicle key-off unit 212 (or unit 212). The VCU 210 may include a plurality of Electronic Control Units (ECUs) 214 disposed in communication with the automotive computer 208.

The automotive computer 208 and/or the unit 212 may be installed anywhere in the vehicle 202, in accordance with the disclosure. Further, the automotive computer 208 may operate as a functional part of the unit 212. The automotive computer 208 may be or include an electronic vehicle controller, having one or more processor(s) 216 and a memory 218. Moreover, the unit 212 may be separate from the automotive computer 208 (as shown in FIG. 2) or may be integrated as part of the automotive computer 208.

The processor(s) 216 may be disposed in communication with one or more memory devices disposed in communication with the respective computing systems (e.g., the memory 218 and/or one or more external databases not shown in FIG. 2). The processor(s) 216 may utilize the memory 218 to store programs in code and/or to store data for performing aspects in accordance with the disclosure. The memory 218 may be a non-transitory computer-readable storage medium or memory storing a key-off program code. The memory 218 may include any one or a combination of volatile memory elements (e.g., dynamic random-access memory (DRAM), synchronous dynamic random-access memory (SDRAM), etc.) and may include any one or more nonvolatile memory elements (e.g., erasable programmable read-only memory (EPROM), flash memory, electronically erasable programmable read-only memory (EEPROM), programmable read-only memory (PROM), etc.).

In accordance with some aspects, the VCU 210 may share a power bus with the automotive computer 208 and may be configured and/or programmed to coordinate the data between vehicle systems, connected servers (e.g., the server 204), and other vehicles operating as part of a vehicle fleet. The VCU 210 may include or communicate with any combination of the ECUs 214, such as, for example, a Body Control Module (BCM) 220, an Engine Control Module (ECM) 222, a Transmission Control Module (TCM) 224, a telematics control unit (TCU) 226, a Driver Assistances Technologies (DAT) controller 228, etc. The VCU 210 may further include and/or communicate with a Vehicle Perception System (VPS) 230, having connectivity with and/or control of one or more vehicle sensory system(s) 232 (or a sensor unit). The vehicle sensory system 232 may include one or more vehicle sensors including, but not limited to, a Radio Detection and Ranging (RADAR or “radar”) sensor configured for detection and localization of objects inside and outside the vehicle 202 using radio waves, sitting area buckle sensors, sitting area sensors, a Light Detecting and Ranging (“lidar”) sensor, door sensors, proximity sensors, temperature sensors, wheel sensors, one or more ambient weather or temperature sensors, vehicle interior and exterior cameras, steering wheel sensors, a vehicle gyroscope, a vehicle magnetometer, ultrasonic sensors, etc.

In some aspects, the VCU 210 may control vehicle operational aspects and implement one or more instruction sets received from the server 204, from one or more instruction sets stored in the memory 218, including instructions operational as part of the unit 212.

The TCU 226 may be configured and/or programmed to provide vehicle connectivity to wireless computing systems onboard and off board the vehicle 202, and may include a Navigation (NAV) receiver 234 for receiving and processing a GPS signal, a BLE® Module (BLEM) 236 or BUN (BLE, UWB, NFC module), a Wi-Fi transceiver, an ultra-wideband (UWB) transceiver, and/or other wireless transceivers (not shown in FIG. 2) that may be configurable for wireless communication (including cellular communication) between the vehicle 202 and other systems (e.g., the server 204), computers, and modules. The TCU 226 may be disposed in communication with the ECUs 214 by way of a bus.

The ECUs 214 may control aspects of vehicle operation and communication using inputs from human drivers, inputs from the automotive computer 208, the unit 212, and/or via wireless signal inputs/command signals received via the wireless connection(s) from other connected devices, such as the server 204, a user device associated with the vehicle user, among others.

The BCM 220 generally includes integration of sensors, vehicle performance indicators, and variable reactors associated with vehicle systems, and may include processor-based power distribution circuitry that may control functions associated with the vehicle body such as lights, windows, security, camera(s), audio system(s), speakers, wipers, door locks and access control, various comfort controls, vehicle features, etc. The BCM 220 may also operate as a gateway for bus and network interfaces to interact with remote ECUs (not shown in FIG. 2).

The DAT controller 228 may provide Level-1 through Level-3 automated driving and driver assistance functionality that may include, for example, active parking assistance, vehicle backup assistance, and/or adaptive cruise control, among other features. The DAT controller 228 may also provide aspects of user and environmental inputs usable for user authentication.

In some aspects, the automotive computer 208 may connect with an infotainment system 238 (or a vehicle Human-Machine Interface (HMI)). The infotainment system 238 may include a touchscreen interface portion, and may include voice recognition features, biometric identification capabilities that may identify users based on facial recognition, voice recognition, fingerprint identification, or other biological identification means. In other aspects, the infotainment system 238 may be further configured to receive user instructions via the touchscreen interface portion, and/or output or display notifications, navigation maps, etc. on the touchscreen interface portion.

The computing system architecture of the automotive computer 208, the VCU 210, and/or the unit 212 may omit certain computing modules. It should be readily understood that the computing environment depicted in FIG. 2 is an example of a possible implementation according to the present disclosure, and thus, it should not be considered as limiting or exclusive.

In accordance with some aspects, the unit 212 may be integrated with and/or executed as part of the ECUs 214. The unit 212, regardless of whether it is integrated with the automotive computer 208 or the ECUs 214, or whether it operates as an independent computing system in the vehicle 202, may include a transceiver 240, a processor 242, and a computer-readable memory 244.

The transceiver 240 may be configured to receive information/inputs from one or more external devices or systems, e.g., the server 204, a user device associated with the vehicle user, and/or the like, via the network 206. Further, the transceiver 240 may transmit notifications, requests, signals, etc. to the external devices or systems or vehicles. In addition, the transceiver 240 may be configured to receive information/inputs from vehicle components such as the VCU 210. Further, the transceiver 240 may transmit signals (e.g., command signals) or notifications to the vehicle components such as the BCM 220, the infotainment system 238, and/or the like.

The processor 242 and the memory 244 may be same as or similar to the processor 216 and the memory 218, respectively. In some aspects, the processor 242 may utilize the memory 244 to store programs in code and/or to store data for performing aspects in accordance with the disclosure. The memory 244 may be a non-transitory computer-readable storage medium or memory storing the key-off program code.

The processor 242 may be an Artificial Intelligence (AI)/Machine Learning (ML) based processor that may be disposed in communication with the memory 244. The memory 244 may include one or more modules that may be trained by the processor 242 using supervised machine learning technique, to learn vehicle feature usage pattern (e.g., to learn a pattern in which the vehicle user/owner may use the vehicle features in key-off mode) and execute vehicle key-off operation. A person ordinarily skilled in the art may appreciate that machine learning is an application of AI using which systems or processors (e.g., the processor 242) may have the ability to automatically learn and enhance from experience without being explicitly programmed. Machine learning focuses on use of data and algorithms to imitate the way humans learn. In some aspects, the machine learning algorithms may be created to make classifications and/or predictions. Machine learning based systems may be used for a variety of applications including, but not limited to, speech recognition, image or video processing, statistical analysis, natural language processing, content generation, pattern identification, and/or the like.

Machine learning may be of various types based on data or signals available to the learning system. For example, the machine learning approach may include supervised learning, unsupervised learning, semi-supervised learning, or reinforcement learning. The supervised learning is an approach that may be supervised by a human. In this approach, the machine learning algorithm may use labeled training data and defined variables. In the case of supervised learning, both the input and the output of the algorithm may be specified/defined, and the algorithms may be trained to classify data and/or predict outcomes accurately.

Broadly, the supervised learning may be of two types, “regression” and “classification”. In classification learning, the learning algorithm may help in dividing the dataset into classes based on different parameters. In this case, a computer program may be trained on the training dataset and based on the training, the computer program may categorize input data into different classes. Some known methods used in classification learning include Logistic Regression, K-Nearest Neighbors, Support Vector Machines (SVM), Kernel SVM, Naïve Bayes, Decision Tree Classification, and Random Forest Classification.

In regression learning, the learning algorithm may predict output value that may be of continuous nature or real value. Some known methods used in regression learning include Simple Linear Regression, Multiple Linear Regression, Polynomial Regression, Support Vector Regression, Decision Tree Regression, and Random Forest Regression.

The unsupervised learning is an approach that involves algorithms that may be trained on unlabeled data. An unsupervised learning algorithm may analyze the data by its own and find patterns in input data. Further, semi-supervised learning is a combination of supervised learning and unsupervised learning. A semi-supervised learning algorithm involves labeled training data; however, the semi-supervised learning algorithm may still find patterns in the input data. Reinforcement learning is a multi-step or dynamic process. This model is similar to supervised learning, but may not be trained using sample data. This model may learn “as it goes” by using trial and error. A sequence of successful outcomes may be reinforced to develop the best recommendation or policy for a given issue in reinforcement learning.

As described above, the modules in the memory 244 may be trained by using supervised machine learning approach. The modules may be updated (or enhanced) as more training data may be fed to the processor 242. In some aspects, the training data may include usage of vehicle features and corresponding inputs/information (such as vehicle location, time, user type, etc.). The processor 242 may learn usage of vehicle features in key-off mode at different scenarios (such as vehicle location, time, user type, etc.), and execute key-off operation accordingly (e.g., select and activate vehicle feature(s) in different scenarios). For example, the processor 242 may learn the usage by creating a lookup table of historical/past usage pattern with current information (such as vehicle location, time, day of week, an identity of a user who last drove the vehicle 102, an identity of a user who is around the vehicle 102, etc.).

In further aspects, the processor 242 may use a neural network model (not shown) to execute the vehicle key-off operation. The neural network model may be stored in the memory 244. The neural network model may be a trained or unsupervised neural network model that may analyze the vehicle feature usage pattern, and facilitate the processor 242 to learn usage of vehicle features in key-off mode in different scenarios (such as vehicle location, time, user type, etc.), and execute vehicle's key-off operation.

In one or more aspects, the neural network model may include electronic data, which may be implemented, for example, as a software component, and may rely on code databases, libraries, scripts, or other logic or instructions for execution of a neural network algorithm by the processor 242. The neural network model may be implemented as code and routines configured to enable a computing device, such as the unit 212, to perform one or more operations. In some aspects, the neural network model may be implemented using hardware including a processor, a microprocessor, a field-programmable gate array (FPGA), or an application-specific integrated circuit (ASIC). In other aspects, the neural network model may be implemented by using a combination of hardware and software.

Examples of the neural network model may include, but are not limited to, a deep neural network (DNN), a convolutional neural network (CNN), a recurrent neural network (RNN), a CNN-recurrent neural network (CNN-RNN), R-CNN, Fast R-CNN, Faster R-CNN, an artificial neural network (ANN), a Long Short Term Memory (LSTM) network based RNN, CNN+ANN, LSTM+ANN, a gated recurrent unit (GRU)-based RNN, a fully connected neural network, a deep Bayesian neural network, a Generative Adversarial Network (GAN), and/or a combination of such networks. In some aspects, the neural network model may include numerical computation techniques using data flow graphs. In one or more aspects, the neural network model may be based on a hybrid architecture of multiple Deep Neural Networks (DNNs).

In operation, the transceiver 240 may receive inputs/information from the VCU 210 and/or the server 204. The inputs/information may include, but is not limited to, the vehicle's current SOC level, a vehicle current location, a vehicle destination location, a distance between the vehicle current location and the vehicle destination location (e.g., the home 106 or the charging station location), information associated with vehicle's historical usage, charging station locations associated with a plurality of charging stations located in proximity to the vehicle current location, and/or the like. Responsive to receiving the inputs/information, the transceiver 240 may store the inputs/information in the memory 244 and/or transmit the inputs/information to the processor 242.

The processor 242 may obtain the inputs/information directly from the transceiver 240 or may obtain the inputs/information from the memory 244, and execute vehicle's key-off mode operation. In some aspects, responsive to obtaining the charging station locations associated with the plurality of charging stations located in proximity to the vehicle current location (from the transceiver 240 or the server 204), the processor 242 may identify a charging station closest to the vehicle current location (or the home 106). The processor 242 may then calculate a distance of the identified closest charging station from the vehicle current location. Stated another way, the processor 242 may determine a vehicle distance from the charging location based on the vehicle current location. Hereinafter, the calculated distance described above is referred to as a vehicle distance from the charging location in the present disclosure.

In further aspects, the processor 242 may determine that the vehicle 202 may be in a key-off mode based on the inputs obtained from the VCU 210. For example, the processor 242 may determine that the vehicle 202 may be in the key-off mode when a vehicle ignition may be turned-off (identified based on inputs obtained from the VCU 210). Responsive to determining that the vehicle 202 may be in the key-off mode, the processor 242 may engage/enable a high-power/high-performance mode for all vehicle features in the key-off mode when vehicle power consumption may not be a concern. For example, the processor 242 may engage/enable the high-power mode for all vehicle features in the key-off mode when the vehicle 202 may be plugged to a charger (as shown in view 302 of FIG. 3), when the vehicle 202 may be located in proximity to a charger (e.g., parked in a home garage with a charging plug easily accessible, as shown in view 304), when the vehicle SOC level may be greater than a threshold, such as 80% (as shown in view 306), when the vehicle distance from the charging location may be less than a threshold value, such as less than 30 miles (as shown in view 308), and/or the like.

In further aspects, responsive to a determination that the vehicle 202 may be in the key-off mode, the processor 242 may determine that a predefined condition may be met based on the vehicle SOC level, the vehicle distance from the charging location, etc. In some aspects, the predefined condition may be met when the vehicle power consumption required to operate the vehicle features may be of concern or there may be a need to conserve vehicle power.

In an exemplary aspect, the predefined condition may be met when the when the vehicle SOC level may be less than a first predetermined threshold (e.g., less than 60% SOC level). In further aspects, the predefined condition may be met when the vehicle distance from the charging location may be greater than a second predetermined threshold (e.g., greater than 50 miles) or when the remaining distance to be travelled by the vehicle 202 on a vehicle trip or to a charging station location/destination location may be greater than the second predetermined threshold. In further aspects, the predefined condition may be met when the processor 242 determines that the time to access the power (e.g., a charger) may be greater than a third predetermined threshold (e.g., more than a couple of hours) based on historical vehicle usage pattern and/or inputs/information obtained from the VCU 210 (e.g., when the vehicle user may be attending an event or located at a restaurant where the vehicle user typically spends considerable time).

Responsive to a determination that the predefined condition may be met, the processor 242 may select one or more vehicle features, from the plurality of vehicle features associated with key-off scenarios, and enable the high-power/high-performance mode only for the selected vehicle features. In this manner, the processor 242 may enable full performance/capacity mode of the selected vehicle features, even if the power consumption may be of concern. For example, the processor 242 may enable the selected vehicle features to operate in full capacity mode, even when the vehicle SOC level may be around 25%.

In some aspects, the processor 242 may select the vehicle features described above by using the AI/ML based trained model described above, which may be trained using historical usage pattern of the plurality of vehicle features. Stated another way, the processor 242 may select the vehicle features based on the historical usage pattern of the plurality of vehicle features in the key-off mode. The historical usage pattern may include usage of vehicle features at different locations, frequency of usage of respective vehicle features, vehicle feature usage by different vehicle users (e.g., authorized users), and/or the combination thereof. In further aspects, the processor 242 may select the vehicle features based on power consumption associated with the respective vehicle feature (or estimated power loss by operating the vehicle feature), user inputs/requests, the vehicle current location, the vehicle current SOC level, the vehicle distance from the charging location, ambient temperature, a time of a day, a day of week, information included in a vehicle user's calendar, and/or the combination thereof.

For example, the processor 242 may learn from the historical usage pattern that the vehicle user typically uses vehicles features “A” and “B” in the key-off mode when the vehicle 202 is located at a home location, and the vehicle user typically uses vehicle feature “C” in the key-off mode when the vehicle 202 is at the parking facility 104 (e.g., a shopping complex parking). In such scenario, the processor 242 may select and enable the high-power mode of the vehicle feature “C” when the vehicle 202 may be parked at the parking facility 104 and when the predetermined condition may be met (e.g., when the vehicle power consumption may be a concern), and may engage low-power mode for the other/remaining vehicle features (including the vehicle features “A” and “B”).

In addition, the processor 242 may learn usage of vehicle features by different users/drivers, and select the vehicle feature accordingly. For example, the processor 242 may learn that a user “AA” typically uses the vehicle features “A” and “C” in the key-off mode, and a user “BB” uses the vehicle feature “B” in the key-off mode. In such cases, the processor 242 may determine whether the vehicle 202 may be used by the user “AA” or “BB” (e.g., based on the inputs from the vehicle sensory system 232, including the vehicle cameras), and then accordingly select the vehicle features. In another example, the processor 242 may learn that the vehicle user typically spends eight hours at an office location. In this case, the processor 242 may correlate the current vehicle SOC level with the average time spent, and select the vehicle feature based on the correlation. In yet another example, the processor 242 may learn the frequency of using vehicle feature(s) in the key-off mode, and select the vehicle feature when the frequency of using a vehicle feature may be greater than a predetermined threshold.

In yet another example, the processor 242 may select a vehicle feature “D” during night time. For example, the processor 242 may select the vehicle's “security” feature when the vehicle 202 may be parked in the home garage during night time. In further aspects, the processor 242 may select the vehicle feature “D” (e.g., the vehicle's security feature) only when the vehicle 202 may be parked at the home location, and not at an office location, as the vehicle 202 may not be required to enable the vehicle's security feature when the vehicle 202 may be parked at the office location (as the office parking may include external security devices). In further example, the processor 242 may use the user inputs to select the vehicle features based on the vehicle's location, time, day, etc.

In additional aspects, the processor 242 may be configured to select an operational level of vehicle feature operation based on the vehicle SOC level and/or the vehicle distance from the charging location. For example, the processor 242 may select an intermediate power mode (e.g., a mode between the high-power mode and the low-power mode) for a vehicle feature when the current SOC level may be between 40-60%. In further aspects, the processor 242 may select the level based on the historical usage pattern of the plurality of vehicle features in the key-off mode.

In further aspects, the processor 242 may be configured to determine a probability of using a vehicle feature in the key-off mode based on the historical usage pattern of the plurality of vehicle features, and select the vehicle feature when the determined probability of using the vehicle feature may be greater than a predetermined threshold.

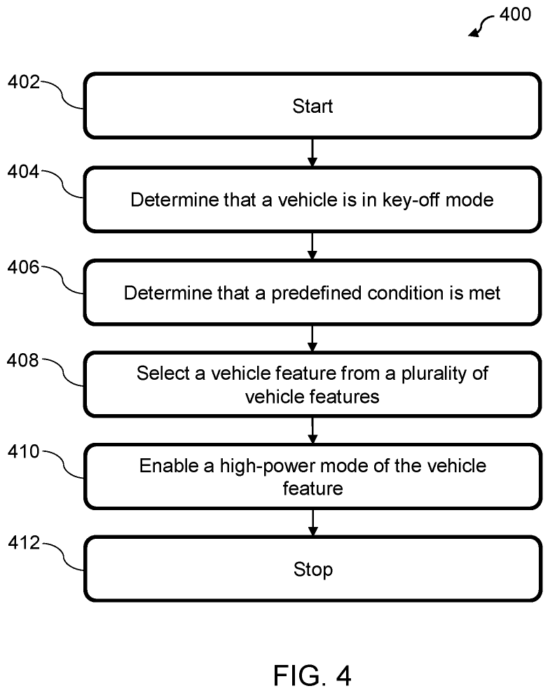

FIG. 4 depicts a flow diagram of a method 400 for operating/engaging vehicle feature(s) in key-off scenario in accordance with the present disclosure. FIG. 4 may be described with continued reference to prior figures. The following process is exemplary and not confined to the steps described hereafter. Moreover, alternative embodiments may include more or less steps than are shown or described herein and may include these steps in a different order than the order described in the following example embodiments.

The method 400 starts at step 402. At step 404, the method 400 may include determining, by the processor 242, that the vehicle 202 may be in the key-off mode. For example, the processor 242 may determine that the vehicle ignition may be turned off.

At step 406, the method 400 may include determining, by the processor 242, that the predefined condition may be met, responsive to determining that the vehicle 202 may be in the key-off mode. The predefined condition may be met when the vehicle power consumption required to operate the vehicle feature may be a concern. In some aspects, the processor 242 may perform such determination based on the information associated with the vehicle SOC level and/or the vehicle distance from the charging location. In some aspects, the processor 242 may first determine the vehicle SOC level and/or the vehicle distance from the charging location based on a vehicle current location, and then determine that the predefined condition may be met based on the vehicle distance and/or the vehicle SOC level.

At step 408, the method 400 may include selecting, by the processor 242, a vehicle feature, from the plurality of vehicle features in the key-off mode, based on the historical usage pattern of the plurality of vehicle features in the key-off mode, responsive to a determination that the predefined condition may be met. At step 410, the method 400 may include enabling, by the processor 242, a high-power mode of the selected vehicle feature, responsive to the selection.

The method 400 may end at step 412.

In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a feature, structure, or characteristic is described in connection with an embodiment, one skilled in the art will recognize such feature, structure, or characteristic in connection with other embodiments whether or not explicitly described.

Further, where appropriate, the functions described herein can be performed in one or more of hardware, software, firmware, digital components, or analog components. For example, one or more application specific integrated circuits (ASICs) can be programmed to carry out one or more of the systems and procedures described herein. Certain terms are used throughout the description and claims refer to particular system components. As one skilled in the art will appreciate, components may be referred to by different names. This document does not intend to distinguish between components that differ in name, but not function.

It should also be understood that the word “example” as used herein is intended to be non-exclusionary and non-limiting in nature. More particularly, the word “example” as used herein indicates one among several examples, and it should be understood that no undue emphasis or preference is being directed to the particular example being described.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Computing devices may include computer-executable instructions, where the instructions may be executable by one or more computing devices such as those listed above and stored on a computer-readable medium.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating various embodiments and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

That which is claimed is:

1. A vehicle comprising:
a transceiver configured to receive a charging station location; and
a processor communicatively coupled to the transceiver, wherein the processor is configured to:
determine that the vehicle is in a key-off mode;
determine at least one of a vehicle State of Charge (SOC) level or a vehicle distance from the charging station location based on a current vehicle location;
determine that a predefined condition is met based on the at least one of the vehicle SOC level or the vehicle distance from the charging station location;
select a vehicle feature from a plurality of vehicle features based on historical usage pattern of the plurality of vehicle features in the key-off mode, responsive to a determination that the predefined condition is met; and
enable a high-power mode of the vehicle feature responsive to the selection.

2. The vehicle of claim 1, wherein the processor is further configured to:
determine a probability to use the vehicle feature in the key-off mode based on the historical usage pattern of the plurality of vehicle features in the key-off mode; and
select the vehicle feature when the probability of using the vehicle feature in the key-off mode is greater than a first predetermined threshold.

3. The vehicle of claim 1, wherein the selection of the vehicle feature is further based on a power consumption associated with each vehicle feature.

4. The vehicle of claim 1, wherein the selection of the vehicle feature is further based on the vehicle SOC level.

5. The vehicle of claim 1, wherein the selection of the vehicle feature is further based on the vehicle distance from the charging station location, and wherein the charging station location comprises a location associated with at least one of an electric vehicle charging station or a fuel station for a hybrid vehicle.

6. The vehicle of claim 1, wherein the selection of the vehicle feature is further based on additional information comprising one or more of: a vehicle current location, an ambient temperature, a time of a day, a day of week, a vehicle user calendar, an identity of a user who last drove the vehicle, and an identity of a user who is around the vehicle.

7. The vehicle of claim 1, wherein the selection of the vehicle feature is further based on user inputs.

8. The vehicle of claim 1, wherein the predefined condition is met when the vehicle SOC level is less than a second predetermined threshold.

9. The vehicle of claim 1, wherein the predefined condition is met when the vehicle distance from the charging station location is greater than a third predetermined threshold.

10. The vehicle of claim 1, wherein the processor is further configured to select an operational level of the vehicle feature based on at least one of the vehicle SOC level or the vehicle distance from the charging station location.

11. A method comprising:
determining, by a processor, that a vehicle is in a key-off mode;
determining, by the processor, at least one of a vehicle State of Charge (SOC) level or a vehicle distance from a charging station location based on a current vehicle location;
determining, by the processor, that a predefined condition is met based on the at least one of the vehicle SOC level or the vehicle distance from the charging station location;
selecting, by the processor, a vehicle feature from a plurality of vehicle features based on historical usage pattern of the plurality of vehicle features in the key-off mode, responsive to a determination that the predefined condition is met; and
enabling, by the processor, a high-power mode of the vehicle feature responsive to the selection.

12. The method of claim 11 further comprising:
determining a probability to use the vehicle feature in the key-off mode based on the historical usage pattern of the plurality of vehicle features in the key-off mode; and
selecting the vehicle feature when the probability of using the vehicle feature in the key-off mode is greater than a first predetermined threshold.

13. The method of claim 11, wherein selecting the vehicle feature is further based on a power consumption associated with each vehicle feature.

14. The method of claim 11, wherein selecting the vehicle feature is further based on the vehicle SOC level.

15. The method of claim 11, wherein selecting the vehicle feature is further based on the vehicle distance from the charging station location.

16. The method of claim 11, wherein selecting the vehicle feature is further based on additional information comprising one or more of: a vehicle current location, an ambient temperature, a time of a day, a day of week, or a vehicle user calendar.

17. The method of claim 11, wherein selecting the vehicle feature is further based on user inputs.

18. The method of claim 11, wherein the predefined condition is met when the vehicle SOC level is less than a second predetermined threshold.

19. The method of claim 11, wherein the predefined condition is met when the vehicle distance from the charging station location is greater than a third predetermined threshold.

20. A non-transitory computer-readable storage medium having instructions stored thereupon which, when executed by a processor, cause the processor to:
determine that a vehicle is in a key-off mode;
determine at least one of a vehicle State of Charge (SOC) level or a vehicle distance from a charging station location based on a current vehicle location, responsive to determining that the vehicle is in the key-off mode;
determine that a predefined condition is met based on the at least one of the vehicle SOC level or the vehicle distance from the charging station location;
select a vehicle feature from a plurality of vehicle features based on historical usage pattern of the plurality of vehicle features in the key-off mode, responsive to a determination that the predefined condition is met; and
enable a high-power mode of the vehicle feature responsive to the selection.
